(19) United States
(12) Patent Application Publication
(10) Pub. No.: US 2003/0233707 A1
(43) Pub. Date: Dec. 25, 2003

(54) Adjustable bed

(76) Inventor: Jonathan Robert East, London (GB)

Correspondence Address: J. R. EAST, 19 ARCHIBALD RD, LONDON, N7 OAN, GB

(21) Appl. No.: 10/314,408

(22) Filed: Dec. 9, 2002

(30) Foreign Application Priority Data
Jun. 24, 2002 (GB) 0214509.2

(51) Int. Cl. A61G 7/00; A61G 7/05

(52) U.S. Cl. 5/613; 5/929

(57) ABSTRACT

An adjustable bed comprising a main frame with mountings for a sub-frame which supports a beam that may be pulled out from under the main frame, leaving a gap between beam and main frame. The beam may be used in this position or may be rotated on the bearings connecting it to the sub-frame so that the highest surface is on the same level as the top of the bed. In either position, one party may lie on the beam and the other party may squat or straddle the first party, using the height adjustment of the bed to assist sexual coupling.

The adjustable bed also incorporates a brace, which is pivoted on a rigid bar attached to the foot of the bed. When in position, the brace may be used as support in a tergo sexual intercourse.

This invention relates to beds, and more particularly to the use of beds for sexual intercourse. The bed that is described has four features, three of them adjustable, which are designed to aid sexual coupling in different positions.

### BACKGROUND

Beds are designed to provide comfortable support for sleeping. Whilst they permit sexual coupling, beds lack some features that could assist it.

Viewed as a gymnastic activity, sexual intercourse is more effective if the movement of one party is transmitted with minimum loss of energy to the other. To avoid loss of energy, the parties need to be able to brace against rigid parts of the bed. The adjustable bed described has provision for such bracing. A second requirement for effective sexual intercourse relates to the relative positions of the two parties. The bed assists this by height adjustment and by the provision of a narrow platform or beam that allows comfortable juxtaposition of the parties. The beam is attached to the bed and is thus also height adjustable.

### SUMMARY OF THE INVENTION

The bed incorporates four features. These are:

1. Height adjustment, which assists sexual positions, for example when the man is standing on the floor and the woman is on the bed.

2. A sub-frame running on under-bed supports for most of the length of the bed, which can be pulled out from under the main part of the bed whilst remaining connected to the bed (in the manner of a drawer). Attached to the sub-frame is a beam, approximately 30 centimetres wide and 25 centimetres high, which extends for most of the length of the bed. When the beam is pulled out from under the bed, a party may lie upon it and another party, with feet on the ground, may straddle or squat over the first party. The height adjustment of the bed may be used to assist contact of the parties. The beam is mounted on the sub-frame via asymmetrically positioned bearings at each end so that, by rotation through 180 degrees, the highest point of the beam is on the same level as the top of the bed. When rotated thus, sexual positions are possible that combine use of the beam and the main part of the bed. For example, a woman could lie on her side with upper leg at right angles across the bed and the man could be straddled over her lower leg. Height adjustment can be used to suit the parties.

3. A rigid bar at the foot of the bed, above the mattress, which permits bracing of feet by an active party. Upon this is mounted,

4. A brace constructed of strong materials and incorporating a cushioned plate. This assists intercourse in the a tergo position. A woman may kneel, resting the plate against either her upper thighs/hips or, with more lordosis, the small of the back. The brace may be stowed when not in use.

### BRIEF DESCRIPTION OF THE DRAWINGS

FIG. 1 is a plan view of the bed showing the beam in an operative condition

FIGS. 2a, 2b and 2c show from an end elevation how the beam may be moved from the storage position to operative positions.

FIG. 3 is an end elevation of the bed showing the brace in a stowed position.

FIG. 4 is a side elevation showing the brace in an operative position.

### DESCRIPTION OF THE OPERATION OF THE BEAM, BAR AND BRACE

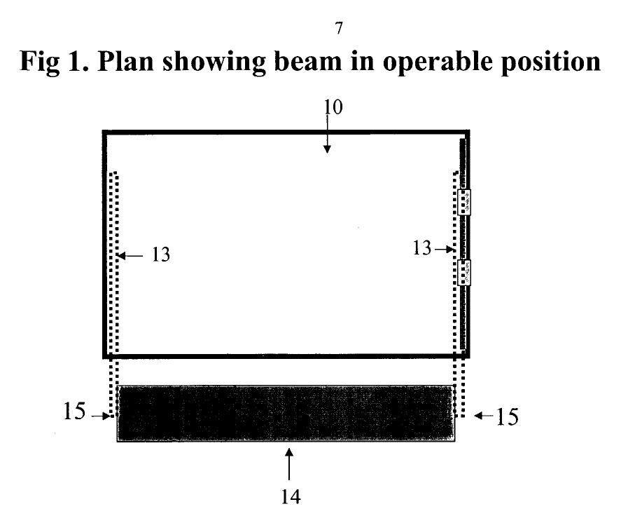

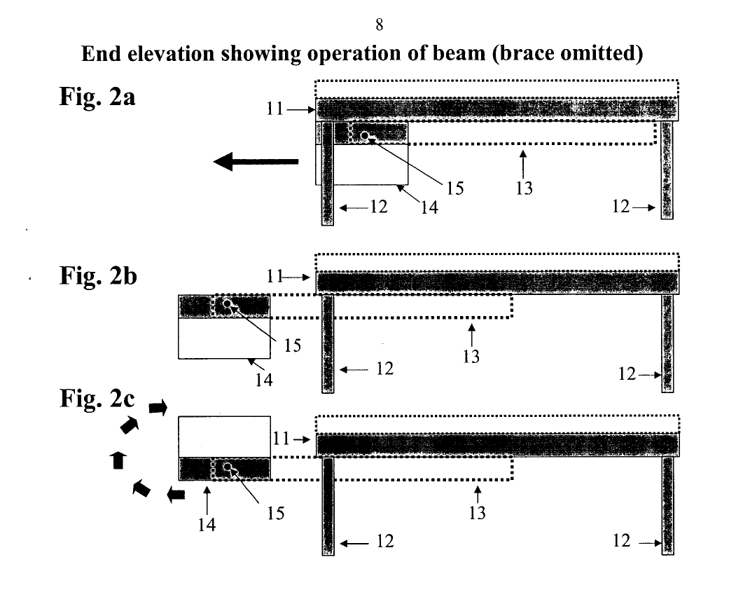

Referring now to FIGS. 1, 2a, 2b, 2c, the bed (10) is shown comprising of a main frame (11), (which carries the mattress) and height adjustable legs (12) for supporting the main frame (11) above the floor. A movable sub-frame (13) is located on under-bed supports below the main frame (11), as shown in FIG. 2a, and this sub-frame supports the beam (14). This permits the beam to be pulled out in the manner of a drawer from the stowed position under the bed to the operative position alongside the bed as shown in FIGS. 1, 2b and 2c.

The beam (14) is connected to the sub-frame (13) via bearings (15) so that the beam can be rotated through 180 degrees on a longitudinal axis as shown in FIG. 2c. The beam is padded top and bottom so that a person may lie on it in comfort whether the beam is rotated through 180 degrees or not. Sexual coupling is possible in both the un-rotated (FIG. 2b) and rotated (FIG. 2c) positions. For example, a man may lie supine and a woman may squat above him, (un-rotated and rotated) or a woman may lie on her side down the beam with her upper leg on the bed and be straddled by the man (rotated). These positions may be aided by the bed-height adjustment, which alters the position of the prostrate party relative to the party who has feet on the ground. The beam may incorporate: a latching mechanism, handles, and its cross-section may be reduced in the central area if required but these features are not shown. Also not shown is any necessary counter-weighting on the bed on the opposite side to the beam.

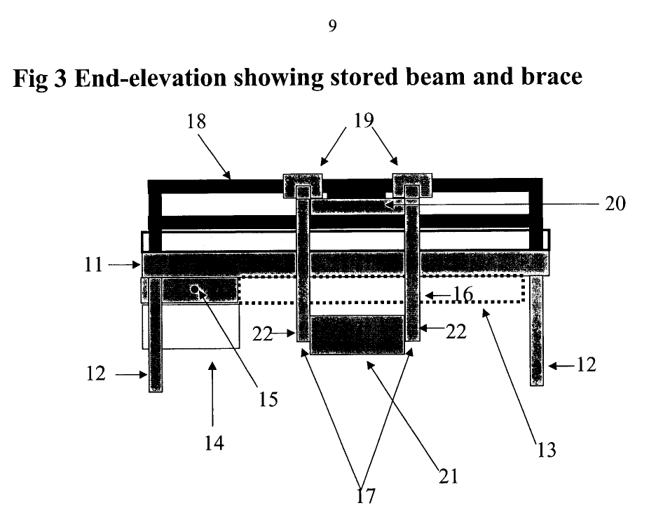

Referring to FIG. 3, the bar (18) is a rigid structure shown as two centrally cross-linked tubes attached to the end-comers of the platform (11). The bar can take foot force from active parties and also serves as the mounting for the brace ( 16).

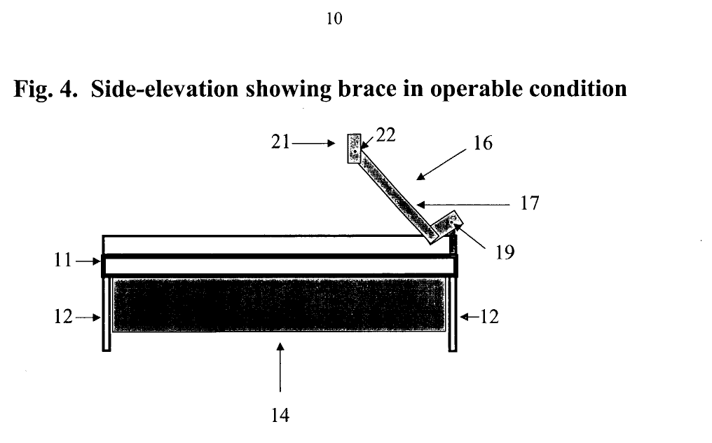

Referring to FIGS. 3 and 4, the operation of the brace (16) is now described. The brace (16) employs a pair of spaced doglegged parallel arms (17) which are each attached to the bar (18) by a pivoting connection (19). A cross member (20) strengthens the brace near the pivots (19) and at the other extremity a transverse cushioned plate (21) is mounted on bearings (22) and connects the doglegged arms (17). The brace (16) is shown in FIG. 3 in the storage position with the parallel arms (17) vertical.

The brace (16) rotates on the bar from the storage position to an operative condition in which the doglegged arms (17) are positioned above the bed as shown in FIG. 4. The brace is particularly suited to the a tergo sexual position, where the man enters the woman from behind. In this position the woman can rest her thigh/hips against the plate and hold onto the parallel arms (17) or the cross-member (20). With substantial arching of the spine it may be possible to use the plate to brace the small of the back.

This adjustable bed assists a popular activity. It uses simple technology in a novel and practical manner to extend the use of a widely possessed item of bedroom furniture.

### RELATED PATENTS

Application No GB 0214509.2 has been filed with the British Patent Office. This application to USPTO incorporates small clarifications of the British application.

Searches have revealed one German patent that describes a device with some parallels to the specification herein. Patent no DE29708828U describes a platform designed to assist sexual coupling by those who may be physically infirm. One component of this platform is a narrow support (rest board) that slides out from a slot in the sub-frame. As described, this component has limited utility since:

1. It is supported at only one end, reducing both the strength of support and the extension possible. My design, supported at both ends, will take the weight of two parties and extends for nearly the whole length of the bed.

2. It lacks height adjustment and cannot be used together with the rest of the platform. Further to this, the German specification does not in practice describe a bed that lends itself to sleeping since it incorporates other structures that obstruct this use. There is a practical and commercial advantage in a product that serves the purpose of rest as well as sex and my design accomplishes this.

1. An adjustable bed comprising a height-variable frame with rigid bar attached at the foot and with under-bed supports that different modes of sexual coupling as well as providing for rest.

2. An adjustable bed as per claim 1, further comprising a brace which rotates on the rigid bar at the foot of the bed to an operative position in which it can be used to support the upper thighs/hips or the small of the back of a woman engaged in a tergo sexual intercourse.

3. An adjustable bed as per claim 1, further comprising a beam that is attached to a sub-frame running on under-bed supports and extending nearly the full length of the bed which can be rotated so that the top of the beam is the same height as the bed and one party can lie full length on the beam or in part on the bed while the other party may straddle or squat above the first party.
